(19) United States
(12) Patent Application Publication
(10) Pub. No.: US 2004/0003534 A1
(43) Pub. Date: Jan. 8, 2004

(54) Process for producing fuel for diesel engine

(76) Inventors: Seishiro Murakami, Kamimashiki-gun (JP); HIdeyuki Fujita, Tokyo (JP)

Correspondence Address: Kanesaka & Takeuchi, 1423 Powhatan Street, Suite 2, Alexandria, VA, 22314, US

(21) Appl. No.: 10/399,448

(22) PCT Filed: Apr. 26, 2001
(86) PCT No.: PCT/JP01/03610

(30) Foreign Application Priority Data
Nov. 10, 2000 (JP) 2000-344156

(51) Int. Cl. C10L 1/18; C10L 1/00

(52) U.S. Cl. 44/307; 44/308

(57) ABSTRACT

A fuel for a diesel engine is produced by using a fish waste oil or a mixture of a vegetable waste oil and the fish waste oil which have conventionally been wasted as a starting material.

Fish oil (virgin oil or fish waste oil) or a mixture of the fish oil and vegetable oil (virgin oil or vegetable waste oil) (hereinafter referred to as “starting material”) is subjected to stirring treatment while introducing ozone, and an oxidation-reduction agent and a polymerization inhibitor are added during the stirring treatment.

Moreover, it comprises the respective steps of a first treatment step in which a stirring treatment is carried out while introducing ozone to the above-mentioned starting material, and an oxidation-reduction agent and a polymerization inhibitor are added during the stirring treatment, a second treatment step in which the material obtained in the above-mentioned first step is filtered and a stirring treatment is further carried out while introducing ozone again, and a step of introducing a vegetable additive to the resulting material by the second treatment step.

### TECHNICAL FIELD

This invention relates to a process for producing a fuel for diesel engine from a substance other than mineral oil such as petroleum, cork or a natural gas, particularly to a process for producing a fuel for diesel engine from waste oil comprising fish oil (virgin oil or fish waste oil) or a mixture of the fish oil and vegetable oil (virgin oil or vegetable waste oil).

### BACKGROUND ART

Reserves of a fossil fuel or mineral oil such as petroleum, cork or a natural gas, etc., buried in the earth are as a matter of course limited, and they are dug and used with a rate of recent years, it is worried to be exhausted within several tens years.

On the other hand, a discharged amount of wastes such as fishes, etc., caught and after utilized for edible, feed or manure is said to be 10,000,000 tons to 15,000,000 tons per year only in Japan, and in the whole world, at least 10-folds or more of the above are supposed to be discharged. A part of such fish wastes is further mechanically squeezed to make a solid or powder, and utilized as a feed for domestic animals or a fertilizer for growing agricultural crops.

A waste liquid generated at the time of squeezing the fish wastes was treated by disposal at sea for several years ago in many parts, but it becomes a cause of ocean pollution and due to increasing a sense of protection for global environment, such a disposal of the fish wastes at sea is prohibited in the respective countries. Thus, disposal of the fish waste at sea is now being prohibited in the respective countries so that it is the present status that related companies or groups are embarrassed how to treat the fish wastes.

After prohibition of the fish wastes at deep-sea disposal, there is an example in which the waste liquid after squeezing the fish waste is mixed with A heavy oil and combusted for a boiler to carry out burning treatment. However, a waste gas which smells of fish generates so that it becomes one of causes of bad smell environmental pollution. Also, it leads to trouble of an oven of a boiler so that many difficult problems remain.

Of 10,000,000 tons to 15,000,000 tons of the fish waste discharged amounts in Japan, fish waste oil mechanically squeezed is said to be discharged in amounts of 4,000,000 tons to 4,500,000 tons per year. It is necessary to consider the solution of the problem rapidly when environmental pollution with a global level is considered.

Moreover, a discharged amount of vegetable waste oil (waste cooking oil) in Japan is said to be about 200,000 tons per year from an enterprise such as fast food chains industry, food processing industry factories, etc., and about 200,000 tons per year from general home, and 400,000 tons in total according to the public announcement.

Shipments of vegetable oil from vegetable oil manufacturers are 1,000,000 tons to 1,500,000 tons per year. From this fact, discharged amount of the vegetable waste oil would be in fact more than the above-mentioned value. An environmental pollution due to the vegetable waste oil (waste cooking oil) is closed up as a social problem and a solution of the problem is urged.

As a kind of vegetable waste oil (waste cooking oil), it can be roughly classified four kinds.

There are high-grade waste oil, medium-grade waste oil, low-grade waste oil and sludge.

(1) With regard to the high-grade waste oil, part thereof is utilized again as feed for a domestic animal, soap or cooking (it has ever exported to abroad but now prohibited).

(2) Part of the high-grade waste oil is utilized as a fuel for a diesel engine by utilizing a methyl esterification technique.

(3) With regard to medium-grade waste oil, low-grade waste oil and sludge, they are treated by burning them by intermediate treatment traders of industrial waste using an auxiliary fuel.

(4) Waste oil discharged from a home is disposed at a burning place of the respective local governments by solidifying the waste oil utilizing a TEMPLE agent for solidifying oils.

(5) As others, a rapacious dealer illegally discharges waste oils and the fact is published by a newspaper as a problem of environmental pollution.

(6) In the waste oil treatment in a home, there are some cases where the waste oil is disposed from a sink of a kitchen as such.

In the situation of advocating environmental improvement with a global level, respective enterprises, respective administrations, and respective local government are worrying themselves about this problem at present since there is no effective solution, but it is the environmental problem to be solved rapidly.

In recent several years, a part of the vegetable waste oil is recycled by “a methyl esterification technique” as a fuel for a diesel engine. This method comprises adding about 30% by weight of methanol or ethanol is added to a vegetable waste oil (an high-grade waste oil), and then, mixing thereto 1% to 1.5% of sodium hydroxide based on the amount of ethanol or methanol as a catalyst and stirring. When the mixture is allowed to stand for the time being, it is separated to layers (an admixture, water, free fatty acid) due to the difference in specific gravities.

Then, to a part of an oil portion taken out is added sodium hydroxide to effect interesterification to make an ester layer and waste glycerin. Part of the ester layer was purified to make a methyl esterified fuel. On the other hand, with regard to part of the waste glycerin, by-products are subjected to neutralization and decomposition and the resulting material is disposed as an industrial waste by an industrial waste dealer for payment.

However, in the fuel technique by methyl esterification, there are problems as mentioned below.

1. Production cost is expensive since an alcohol (methanol or ethanol) is introduced in an amount of 30% by weight to 50% by weight based on the starting material (vegetable waste oil).

2. An alcohol is used with a large amount so that plant construction cost is expensive for prevention against disasters.

3. There is a problem in safety of workability.

4. A yield after purification is poor. Also, among the waste oil, only high-grade waste oil can be purified.

5. An alcohol and sodium hydroxide are used so that they are used as a fuel, formaldehyde, acrolein, benzene, etc., are discharged in a discharged gas with much amount than in the case of using light oil so that is cannot be said to be a clean fuel.

6. An alcohol is used so that a trouble is likely caused at a piston, a piston ring, inside of a head in a diesel engine.

7. Medium-grade waste oil, low-grade waste oil and sludge cannot be purified so that it cannot be bound up with environmental improvement.

Thus, the present inventors have previously invented a method for purifying vegetable oil (virgin oil) or vegetable waste oil for the use of a diesel engine fuel (Japanese Laid-Open Patent Application No. 2000-219886) for the purpose of overcoming the defects involved in the above-mentioned methyl esterification technique.

This method is to act water and ozone on heated vegetable oil (virgin oil) or vegetable waste oil to separate and remove impurities such as glycerin or animal oils and fats, etc. in the vegetable oil (virgin oil) or vegetable waste oil. This method is a method of regenerating the vegetable waste oil to a fuel for a diesel engine but fish waste oil is not referred to therein. With regard to the fish waste oil or animal waste oil, it has just started to study as a fuel for a diesel engine at several laboratories in a university so that a significant time would be required to obtain a result.

Thus, the technique of the present invention is to overcome all of these problems and to propose as a technique which is capable of preventing environmental pollution and improving environment with a global level. That is, the technique of the present invention is to purify fish waste oil to give a fuel of a diesel engine whereby environmental pollution is prevented. Moreover, it can make an exhaust gas of the diesel engine a clean exhaust gas and a lifetime of a mineral oil can be elongated.

Also, the present invention is to propose a novel method for regeneration of vegetable waste oil which was not sufficiently spread due to the defects of the methyl esterification technique, whereby the vegetable waste oil can be purified without using any chemical materials and purification can be carried out even when the fish waste oil and the vegetable waste oil are mixed at the stage of the starting material. Moreover, even when it is mixed during purification, the purification procedure can be finished. Furthermore, this is a purification technique causing no problem even when products purified the fish waste oil and the vegetable waste oil each independently are mixed after the purification.

A cost for constructing the plant of this technique is not expensive and a manufacturing cost is also cheap so that a market competitive power is high. Further, it is an object of the present invention to provide “a method of purifying animal and vegetable oils (virgin oil) and animal and vegetable waste oils to produce a fuel for a diesel engine” which regenerates oil having good quality than light oil.

### DISCLOSURE OF THE INVENTION

Thus, the present invention is a process for producing a fuel for a diesel engine which comprises subjecting to stirring treatment of waste oil comprising fish oil (virgin oil or fish waste oil) or a mixture of the fish oil and vegetable oil (virgin oil or vegetable waste oil) while introducing ozone, and adding an oxidation-reduction agent and a polymerization inhibitor during stirring treatment.

Moreover, the invention is a process for producing a fuel for a diesel engine which comprises a first treatment step of subjecting to stirring treatment of waste oil comprising fish oil (virgin oil or fish waste oil) or a mixture of the fish oil and vegetable oil (virgin oil or vegetable waste oil) while introducing ozone, and adding an oxidation-reduction agent and a polymerization inhibitor during stirring treatment, a second treatment step of subjecting to a filtration step and an ozone treatment step again, and adding a vegetable additive to the resulting pre-product starting material to obtain a product.

In the present invention, the fish oil (virgin oil or fish waste oil) or the vegetable oil (virgin oil or vegetable waste oil) which become a starting material is a starting material derived from various sources so that it is preferred to remove impurities in the starting material by subjecting to pretreatment. These above-mentioned fish oil (virgin oil or fish waste oil) are obtained by mechanically squeezing the fish waste oil and filtering the same.

To remove impurities in the starting material, the filtrating agent to be used in the above-mentioned filtration step may be activated clay, diatomaceous earth, zeolite, activated charcoal, or bone black, and is used in an amount of 20 to 25 kg based on 1 kiloliter of the starting material.

An ozone concentration to be used in the above-mentioned ozone injection is 500 to 30000 ppm, and a desirable concentration is 2000 to 10000 ppm.

Stirring at the above-mentioned first treatment is carried out with a rate of 250 rotations to 1,000 rotations per minute for 60 minutes, and stirring at the above-mentioned second treatment is carried out with a rate of 100 rotations to 300 rotations per minute for 30 minutes to 120 minutes.

The above-mentioned oxidation-reduction agent is a ferric oxide compound, etc., or a cupper compound, and is added in an amount of 0.15 g per liter of the starting materials.

The above-mentioned polymerization inhibitor is a phosphorus compound and is added in an amount of 0.2 g to 0.25 g per liter of the starting materials.

Also, to prevent crystallization at winter season which is a defect of the starting materials, a crystallization preventive agent comprising castor oil, etc. is added during the above-mentioned second treatment. An added amount of the above-mentioned crystallization preventive agent is 0.05 to 0.1% by weight based on the starting materials.

Moreover, the above-mentioned vegetable additive to uniform the product is added in an amount of 2 to 5% by weight based on the starting materials, and the mixture is stirred to form a product.

A whole flow sheet of the process for producing a fuel for a diesel engine according to the present invention is shown in FIG. 6.

### BRIEF DESCRIPTION OF THE DRAWINGS

FIG. 1 is a drawing showing a pretreatment filtration device by a pressure type filter press to be used for the preparation process of a fuel for a diesel engine according to the present invention.

FIG. 2 is a drawing showing a pretreatment filtration device by a suction type filtration device to be used for the preparation process of a fuel for a diesel engine according to the present invention.

FIG. 3 is a drawing showing a propeller type first treatment device to be used for the preparation process of a fuel for a diesel engine according to the present invention.

FIG. 4 is a drawing showing a brush type first treatment device to be used for the preparation process of a fuel for a diesel engine according to the present invention.

FIG. 5 is a drawing showing an adjustment device before making a product to be used for the preparation process of a fuel for a diesel engine according to the present invention.

FIG. 6 is a flow chart showing a whole process of the production method of a fuel for a diesel engine according to the present invention.

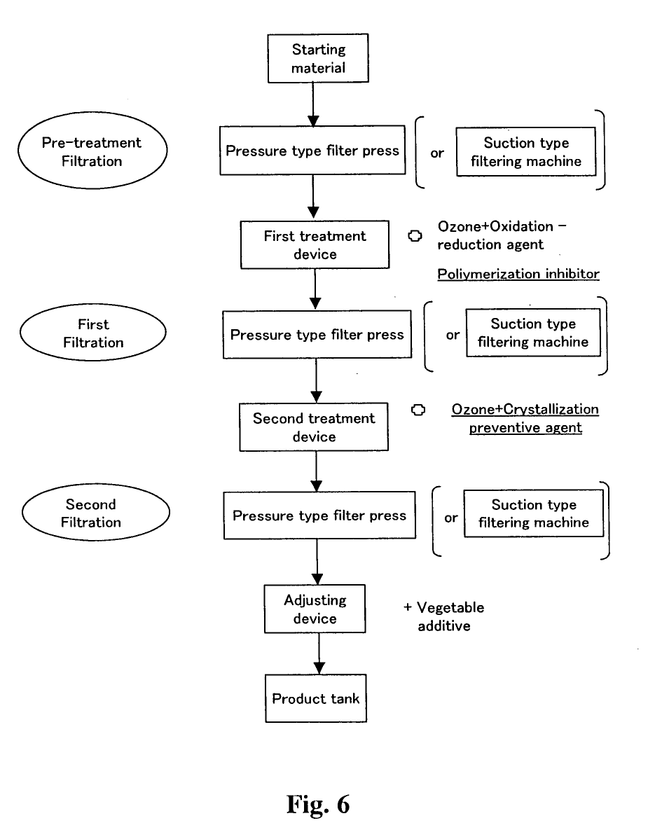

### BEST MODE FOR CARRYING OUT THE INVENTION

The process of the production method of a fuel for a diesel engine according to the present invention is described in detail below.

The starting material of the present invention is fish oil (virgin oil or fish waste oil) or fish waste oil comprising a mixture of the above-mentioned fish oil and vegetable oil (virgin oil or vegetable waste oil). Diesel engine fuel oil is produced from the starting material, and the whole step of the preparation method is explained in more detail.

(1) Pretreatment filtration step

(2) First treatment step

(3) First filtration step

(4) Second treatment step

(5) Second filtration step

(6) Adjustment step before making product

The above-mentioned six steps are explained in detail by referring to the explanation drawings.

[Pretreatment Filtration Step]

In the fish waste oil, vegetable oil and vegetable waste oil, there are a great variety of oils. That is, depending on the enterprises, kinds of offices and contents of business which discharge the starting materials, various impurities are migrated (example: fried food waste, waste of fish, waste of meat, etc.) so that it is preferred to remove impurities. As a method thereof, a pressure type filter press or a suction type filter is used. As a kind of a filtering medium to be used for filtration, there may be mentioned an activated clay, diatomaceous earth, zeolite, activated charcoal, bone black, etc. Also, different kinds of filtering media may be used in admixture. An amount of the filtering medium to be used is made 20 kg to 25 kg per I kiloliter of the starting material.

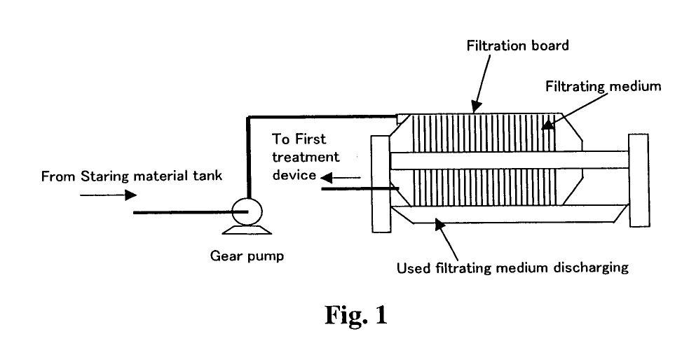

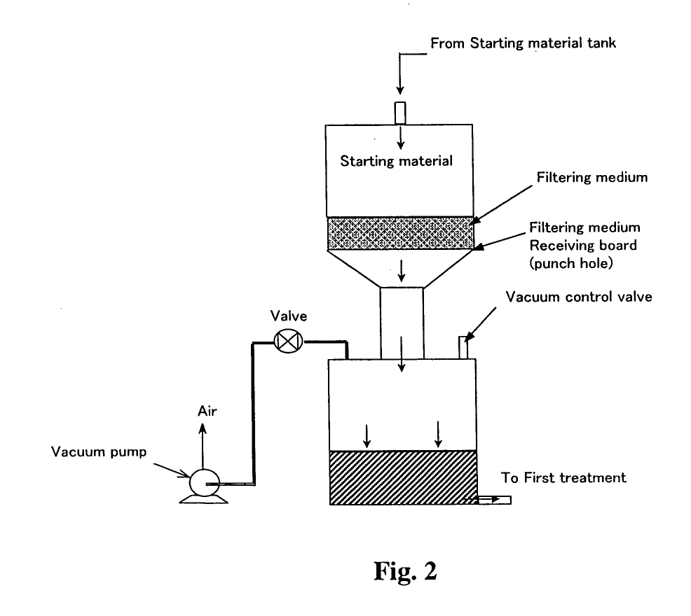

The case of the pressure type filter press is shown in FIG. 1 and the case of the suction type filtering device is shown in FIG. 2, respectively.

The starting material passed through the pretreatment filtration step is transferred to the first treatment device as a clean starting material from which impurities are removed.

[First Treatment Step]

The starting material completed the pretreatment filtration step is transferred to the first treatment device.

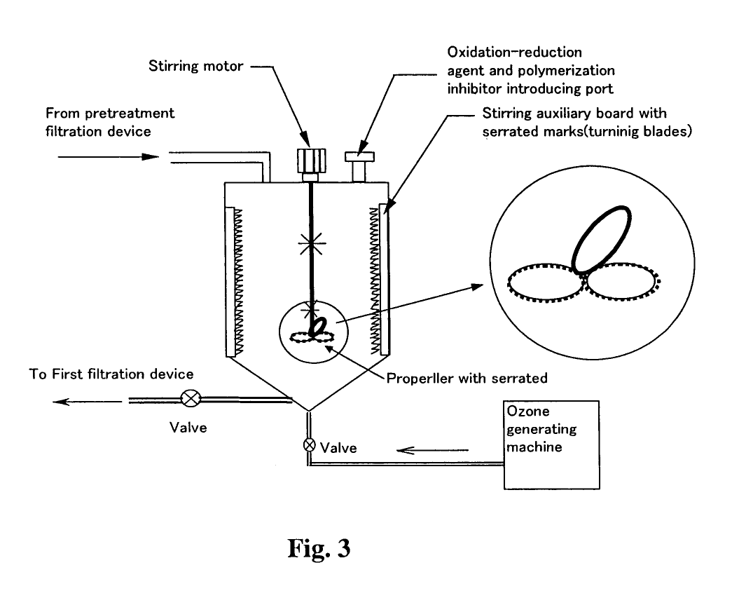

In FIG. 3, the first treatment device is shown. An inlet of the starting material from the pretreatment filtration step and an introducing port of an oxidation-reduction agent and a polymerization inhibitor are provided at the upper portion of the first treatment device, and an ozone inlet port is provided at the bottom of the inside of the device, respectively. Also, a stirring rod is provided at the center of the device. To the stirring rod, a propeller is provided at the portion slightly upper than the ozone inlet port. To the propeller, specific processing is applied and serrated marks are attached at the surroundings of the tip end of the propeller. Or else, a wire brush may be provided with a lateral axis at the portion slightly upper than the ozone inlet port. An object of the above is to finely pulverize the starting material at the time of stirring. Also, it is to finely pulverize the ozone gas. Moreover, at the time of stirring, a usual stirring blade is attached just at the upper portion of the above-mentioned specific propeller or the lateral axis wire brush. Also, it is preferred to provide iron plates (so-called turning blades) to which serrated marks are attached having a width of 10 cm to 15 cm at four portions of the outside wall at the inside of the first treatment device from the upper portion to the bottom portion.

In such a first treatment device, the starting material passed through the pretreatment filtration device is introduced from the starting material inlet at the upper portion and ozone is taken therein from the ozone inlet port at the bottom portion. An ozone concentration to be used is made 500 ppm to 1,000 ppm or 4,000 ppm to 30,000 ppm. Or else, it may be 2,000 ppm to 10,000 ppm.

These starting materials are thoroughly stirred. A stirring rate is inherently desired to be 10,000 rotations to 30,000 rotations per minutes but it is dangerous in the point of safety for operation so that it is made 250 rotations to 350 rotations or 500 rotations to 1,000 rotations per minute. Here, a desired rotation rate in the present stirring is 250 rotations to 350 rotations per minute. To obtain the same stirring ability with 10,000 rotations to 30,000 rotations, the propeller is subjected to specific processing whereby serrated marks are attached thereto or a number of needle-like wiring brush is used, the problem of ultra-high speed rotation can be solved. Also, as an effect of ultra-high speed rotation, natural electromagnetic wave occurs in the starting materials. According to the matter, an ozone decomposition reaction can be carried out rapidly and certainly.

By carrying out stirring, finely pulverized particles of the starting materials and ozone are mixed with each other in a particle level to promote oxidation of the starting materials whereby glycerin and fatty acid in the starting materials are separated from the starting materials, decomposed and floated. This is called as breaking or a cracking phenomenon of the starting materials. Incidentally, oxidation is controlled by adding 0.15 g of an oxidation-reduction agent based on 1 liter of the starting materials so that the starting material is not excessively oxidized. Thus, a saturated fatty acid is changed to an unsaturated fatty acid by ozone decomposition, i.e., to ozonide causing an olefin effect. The ozonide forms aldehyde or ketone by a reducing agent which is becoming a state to easily become a fuel. When oxidation is excessively occurred, there is a possibility that the starting material causes a polymerization reaction, so that 0.2 g to 0.25 g of a polymerization inhibitor is added per 1 kiloliter of the starting materials. This treatment step is carried out for 60 minutes.

[First Filtration Step]

In this step, a pressure type filter press or suction filtration is carried out. The device to be used in this procedure is completely the same as those shown in FIG. 1 and FIG. 2 as the pretreatment filtration device. A purpose of the filtration is to remove glycerin, fatty acid, etc., which are floating materials extracted from the starting materials in the first treatment, or the oxidation-reduction agent and the polymerization inhibitor used in the reaction. A filtering medium to be used in this step may be either of an activated clay, diatomaceous earth, zeolite, activated charcoal, bone black, etc. Also, various kinds of filtering media may be used in admixture. An amount of the filtering medium to be used is 20 kg to 25 kg per 1 kiloliter of the starting materials. The starting material passed through the first filtration step becomes a starting material having a significantly high purity, flammability is the same as that of mineral oil and an ignitable property appears after the filtration step.

[Second Treatment Step]

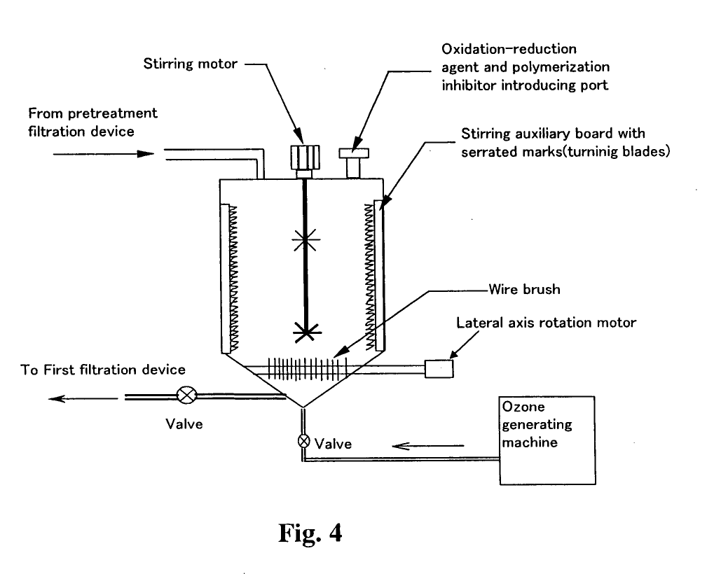

The starting materials completed the first filtration step is transferred. The second treatment device is the similar device to that of the first treatment device, and an ozone inlet port is provided at the end portion of the device. And the similar shape stirrer and turning blades to those of the first treatment device are provided at the similar position thereto (see FIG. 3 and FIG. 4). The starting materials passed through the first filtration device are introduced into the second treatment device, and ozone is added to the starting materials from the ozone inlet port at the bottom portion of the second treatment device and stirring was carried out. An ozone concentration is 500 to 30,000 ppm, and a desired concentration is 2,000 to 10,000 ppm. A stirring rate may be 100 to 300 rotations per minute, and it may be preferably 200 to 300 rotations per minute. Preferably it may be only bubbling by flown ozone. An object of the secondary treatment is to further finely pulverize the finely pulverized starting particles pulverized in the first treatment device whereby the resulting material completely burns when it is used in an internal combustion engine.

To prevent crystallization at the winter season which is a defect of the starting materials, 0.05% to 0.1% by weight of a crystallization preventive agent is added to the starting materials. As the crystallization preventive agent, castor oil, etc., is used. Also, discoloration and deodorization effects which are characteristic features of ozone can be shown. A treatment time by the second treatment device is 60 to 90 minutes, or else, it may be 30 to 120 minutes.

[Second Filtration Step]

The starting materials finished in the second treatment step are passed through a second filtration device.

As an object, if a floating material, etc., is remained after the step of the first treatment, and assuming that a floating material is newly appeared in the second treatment device, they are removed in the second filtration step. According to this procedure, purity of the product is improved.

A filtering medium to be used in this step may be either of an activated clay, diatomaceous earth, zeolite, activated charcoal, bone black, etc. Also, various kinds of filtering media may be used in admixture.

[Adjustment Step Before Making Product]

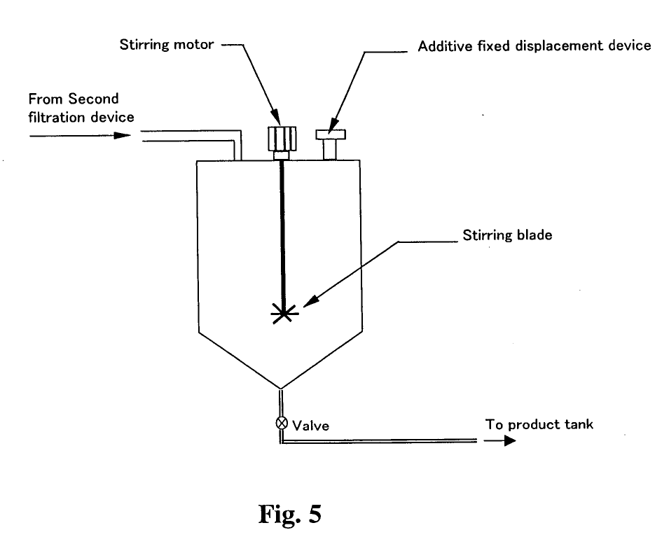

The starting material passed through the second filtration device and before the product is transferred to the adjustment device before making the product. The adjustment device before making the product is, as shown in FIG. 5, a tank having a stirrer at the center portion of the device, and having an inlet for introducing starting materials and an additive at the upper portion and a product taken out port at the bottom portion. This step is a step of adjusting the starting materials passed through the second filtration step finally as a fuel for a diesel engine.

The starting materials passed through the second filtration device are in the state substantially close to the product, but the starting materials include various kinds of oils. To unify the product, an additive extracted from raw (or root?) of vegetable is added in an amount of 2 to 5% by weight and the mixture is stirred for 30 minutes. Stirring is carried out by using a usual blade, and a stirring rate may be 150 to 200 rotations per minute.

After finishing this step, the resulting material becomes a complete fuel for a diesel engine.

Analytical results of an example of a fuel purified by the present invention after finishing the above steps are shown in Table 2 below.

TABLE 2

| | | | Methyl- | Methyl- | Methyl- | | |
|---|---|---|---|---|---|---|---|
| | | | esterification | esterification | esterification | | |
| | | Light oil | Domestic | EU | Domestic | Revive fuel | Revive fuel |
| | Unit | (Idemitsu) | standard | standard | company | (vegetable) | (fish oil) |
| Density 15° C. | G/cm³ | 0.8350 | 0.86 to 0.90 | 0.86 to 0.90 | 0.8828 | 0.8758 | 0.8736 |
| Flash point | ° C. | 65 | Min 100 | Min 100 | 130.1 | 51.3 | 38 |
| Clogging point | ° C. | −8 | Max −5 | Max −15 | −6 | −37 | −15 |
| Total exotherm | Kcal/kg | 10,920 | 9,500 | 9,500 | 9,490 | 9,730 | 10,700 |
| Distillation | ° C. | 170 | No | No | 185 | 161.5 | 131.0 |
| test Initial | | | designation | designation | | | |
| boiling point | | | | | | | |
| 10% ° C. | ° C. | 220 | No | No | 320 | 181.5 | 161.0 |
| | | | designation | designation | | | |
| 50% ° C. | ° C. | 280 | No | No | 337 | 216.0 | 197.0 |
| | | | designation | designation | | | |
| Terminal point | ° C. | 360 | No | No | 362 | 342.0 | 316.0 |
| ° C. | | | designation | designation | | | |
| Sulfur content | % | 0.2 or less | Max 0.01 | Max 0.01 | 0.01 | 0.01 | 0.00 |

As can be clearly seen from the above table, the fuel purified by the technique of the present invention (the revive fuel in the table) has clearly high purity than the methyl esterification method of EU standard in Japan. In particular, when it is compared with a certain company who is actually carrying out purification in Japan, the difference in purity is clearly shown. In the analyses as a fuel, the values obtained by the distillation tests are important. As shown in the table, in the distillation test, the revive fuel showed excellent numerical values than the Idemitsu light oil. From this result, it can be understood that the liquid particles are so finely minimized. To finely minimize the particles of the fuel means that incomplete combustion can be prevented and complete combustion can be carried out when it is used for an internal combustion engine. When complete combustion is carried out, no harmful substance is contained in an exhaust gas and no graphite occurs. Accordingly, it can be convinced of improvement in environmental pollution by an exhaust gas exhausted from a diesel engine which is now becoming a social problem.

In the following, the present invention is explained in more detail by referring to Examples.

### EXAMPLE 1

Fish waste oil squeezed mechanically from fish waste and fish oil (virgin oil) are used as starting materials. By using a pressure type filter press, 1 kiloliter of the starting materials was passed through the filter press to remove impurities such as waste of offals of fish, an admixture, etc. At this time, activated clay is used as a filtering medium. The starting materials (fish oil, fish waste oil) from which impurities are removed are transferred to a first treatment device. At the first treatment device, as shown in FIG. 3, the starting materials are introduced into the treatment tank from the upper portion of the treatment tank, and ozone is fed from an ozone inlet port at the bottom of the tank with an ozone concentration of 2,000 to 10,000 ppm while stirring. During the stirring, ferric oxide is added as an oxidation-reduction agent and a phosphorus compound is added as a polymerization inhibitor, and the treatment is carried out about 60 minutes. Incidentally, a rotation rate of the stirrer was 500 to 1,000 rotations/minute. After completion of the first treatment, the starting material was transferred to a first filtration device to remove impurities such as glycerin, a fatty acid, etc., generated by the reaction.

The starting materials passed through the first filtration device are transferred to a second treatment device, and ozone is introduced thereinto from an ozone bung hole at the bottom of the device. An ozone concentration is 2,000 to 10,000 ppm and a stirring rate is 200 to 400 rotation/minute. Castor oil is added as a crystallization preventive agent in an amount of 0.05 to 0.1% by weight based on the weight of the starting materials. A treatment time was 60 to 90 minutes. The starting material finished from the second treatment is passed through a second filtration device to produce a final product. A filtrating medium was activated clay. After passing through the second filtration device, the materials is transferred to an adjusting device before making a product, and 2 to 5% by weight of a vegetable additive was added per 1 kg of the starting materials, and the mixture was stirred for about 30 minutes, whereby the starting materials could be made a product as a complete fuel for a diesel engine.

Utilizability in Industry

As described above, in the present invention, when the ozone treatment is carried out, an oxidation-reduction agent and a polymerization inhibitor are added, or the above-mentioned treatment is carried out as the first treatment, subsequently, a series of the procedure containing a second treatment by using ozone, vegetable waste oil containing fish waste oil, including fish waste oil which could never be treated by the conventional method can be lead to a fuel for a diesel engine so that its effect is large.

1. A process for producing a fuel for a diesel engine which comprises subjecting waste oil comprising fish oil (virgin oil or fish waste oil) or a mixture of the fish oil and vegetable oil (virgin oil or vegetable waste oil) to stirring treatment while introducing ozone, and adding an oxidation-reduction agent and a polymerization inhibitor during the stirring treatment.

2. A process for producing a fuel for a diesel engine which comprises a first treatment step of subjecting waste oil comprising fish oil (virgin oil or fish waste oil) or a mixture of the fish oil and vegetable oil (virgin oil or vegetable waste oil) while introducing ozone to stirring treatment, and adding an oxidation-reduction agent and a polymerization inhibitor during the stirring treatment,
a second treatment step of subjecting to a filtration of the material obtained by the above-mentioned first treatment step and subjecting to stirring treatment while injecting ozone into the mixture again, and
a step of adding a vegetable additive to the resulting material obtained in the second treatment step.

3. The process for producing a fuel for a diesel engine according to claim 1 or 2, wherein the fish oil is obtained by compressing fish or fish waste and filtering the resulting material.

4. The process for producing a fuel for a diesel engine according to claim 1 or 2, wherein the filtering material is activated clay, diatomaceous earth, zeolite, activated charcoal or bone black, and is used in an amount of 20 to 25 kg based on 1 kiloliter of the starting material.

5. The process for producing a fuel for a diesel engine according to claim 1 or 2, wherein a concentration of ozone to be used in the ozone injecting treatment is 2,000 to 10,000 ppm.

6. The process for producing a fuel for a diesel engine according to claim 2, wherein the stirring carried out in the first treatment step is carried out at a rate of 250 rotations to 1,000 rotations per minute for 60 minutes, and the stirring carried out in the second treatment step is carried out at a rate of 100 rotations to 300 rotations per minute for 30 minutes to 120 minutes.

7. The process for producing a fuel for a diesel engine according to claim 1 or 2, wherein the oxidation-reduction agent is an iron compound such as ferric oxide, etc., or a copper compound and used in an amount of 0.15 g per 1 kiloliter of the starting material.

8. The process for producing a fuel for a diesel engine according to claim 1 or 2, wherein the polymerization inhibitor is a phosphorus type compound and is used in an amount of 0.2 g to 0.25 g per 1 kiloliter of the starting material.

9. The process for producing a fuel for a diesel engine according to claim 2 or 6, wherein a crystallization preventive agent is further added to the mixture in the second treatment step.

10. The process for producing a fuel for a diesel engine according to claim 8, wherein the crystallization preventive agent is used in an amount of 0.05 to 0.1% by weight based on the starting materials.

11. The process for producing a fuel for a diesel engine according to claim 2, wherein the vegetable additive is added in an amount of 2 to 5% by weight based on the starting materials.
